(19) United States
(12) Patent Application Publication
(10) Pub. No.: US 2020/0320617 A1
(43) Pub. Date: Oct. 8, 2020

(54) AUTOMATED INTEREST RATE MODIFICATION FOR STUDENT LOANS IN A TUTOR MATCHING SYSTEM

(71) Applicant: The Other Right, LLC, Miami, FL (US)

(72) Inventors: James Nicolo Bates, Miami, FL (US); Eduardo Burillo, Miami, FL (US)

(21) Appl. No.: 16/374,723

(22) Filed: Apr. 3, 2019

(51) Int. Cl. G06Q 40/02; G06Q 50/20; G09B 5/14

(52) U.S. Cl. CPC G06Q 40/025; G09B 5/14; G06Q 50/205

(57) ABSTRACT

The automated modification of a student loan interest rate includes periodically retrieving for an end user of a tutor matching system for a duration of time during which the end user remains enrolled at an academic institution, a contemporaneous indication of grades for coursework for which the end user has registered at the institution. In response to each retrieval, the contemporaneous indication of grades is transmitted in a query to a student loan banking system through a query interface to the student loan banking system. Then, a response to the query is received indicating a specified variable interest rate for a student loan to the end user and a prospective reduced interest rate in consequence of the contemporaneous indication of the grades. Finally, the specified variable interest rate, the prospective reduced interest rate and the contemporaneous indication of grades are displayed in a user interface to the tutor matching system.

### BACKGROUND OF THE INVENTION

### Field of the Invention

The present invention relates to computer managed lending and more particularly automated interest rate management for student loans.

### Description of the Related Art

In finance, a loan is the lending of money by one or more individuals, organizations, or other entities to other individuals, organizations or entities. Generally, a loan from a lender to a borrower provides for an amount loaned, and an interest rate along with a period of time over which the loan is to be paid back with interest by the borrower to the lender. Of note, the interest rate may be fixed or variable and interest payments may be required periodically or at the termination of the loan at the end of the loan period. Typically, the loan is secured with collateral such as real estate or a large, resalable asset such as a car. But, instead of collateral, in some instances, a loan may be guaranteed by a third-party. Such is the case with some student loans.

A student loan is a type of loan in which a student receives funding for the sole purpose of paying tuition and ancillary expenses in furtherance of a higher education such as undergraduate or graduate studies. Student loans also are awarded for vocational and community college studies. In most instances, the student loan interest rate is determined at the time of underwriting, but principal and interest payments do not commence until some small period of time subsequent to graduation so as to afford the opportunity of the borrower to find gainful employment in consequence of which the student can then afford to make the requisite loan payments.

Importantly, at the time receiving a student loan at a specified interest rate, the student barely has an awareness or understanding of the impact of the specified interest rate. After all, the sheer excitement of attending college overshadows all other future concerns, many years away from materialization. Yet, once the college experience has ended, the resulting wage can be quite low and, in many instances, insufficient to support large loan repayment obligations. In particular, the burden of a very high interest rate can only compound the difficulties in repaying a student loan. Of course, the college graduate who performs well during college is more likely to receive a job with a higher wage than the college graduate who had performed poorly. But, through the college experience, many students remain detached from this reality and in many instances, do not perform as well as possible for lack of a real-world motivation that outweighs the many reasons that students perform poorly, such as extracurricular distractions, social distractions and familial distractions.

### BRIEF SUMMARY OF THE INVENTION

Embodiments of the present invention address deficiencies of the art in respect to student loan processing and provide a novel and non-obvious method, system and computer program product for the automated modification of a student loan interest rate in a tutor matching system. In an embodiment of the invention, the method includes periodically retrieving for an end user of the tutor matching system for a duration of time during which the end user remains enrolled at an academic institution, a contemporaneous indication of grades for coursework for which the end user has registered at the academic institution. In response to each retrieval, the contemporaneous indication of the grades is transmitted in a query to a student loan banking system through a query interface to the student loan banking system. Then, a response to the query is received that indicates a specified variable interest rate for a student loan to the end user and a prospective reduced interest rate in consequence of the contemporaneous indication of the grades. Finally, each of the specified variable interest rate, the prospective reduced interest rate and the contemporaneous indication of grades are displayed in a user interface to the tutor matching system.

In one aspect of the embodiment, the contemporaneous indication of the grades is a grade point average (GPA). In another aspect of the embodiment, the contemporaneous indication of the grades is a change in GPA over time. In yet another aspect of the embodiment, the method additionally includes displaying in the user interface a date on which the prospective reduced interest rate becomes fixed. In even yet another aspect of the embodiment, the method additionally includes displaying in the user interface a threshold value beyond the contemporaneous indication of grades at which an even further reduced interest rate occurs.

Of note, in another aspect of the embodiment, the periodic retrieval of the contemporaneous indication of the grades includes identifying a pre-stored profile in the tutor matching system for the academic institution, extracting from the pre-stored profile, a network address of a registrar data retrieval system and a specification of a query interface to the registrar data retrieval system, generating a query consistent with the specification to retrieve a transcript for the end user, transmitting the generated query to the network address of the registrar data retrieval system, receiving in response to the generated query, transcript data that includes a listing of courses for which the end user has registered and corresponding grades and computing the contemporaneous indication of the grades from the corresponding grades in the transcript data.

In another embodiment of the invention, a tutor matching data processing system is configured for automated modification of a student loan interest rate. The system includes a host computing platform that has a data store and one or more computers, each with memory and at least one processor, the host computing platform having a communicative coupling to different mobile devices of different end users over a computer communications network. The system also includes a tutor matching engine executing in the host computing platform. The engine matches students requesting tutoring services from respective ones of the mobile devices, with tutors accepting the requested tutoring services from respective ones of the mobile devices. Finally, the system includes an automated student loan interest rate modification module.

The module includes computer program instructions enabled during execution in the memory of the host computing platform to periodically retrieve for one of the end users of the tutor matching system for a duration of time during which the one of the end users remains enrolled at an academic institution, a contemporaneous indication of grades for coursework for which the one of the end users has registered at the academic institution. The program instructions also are enabled to respond to each retrieval of the contemporaneous indication of the grades by transmitting the contemporaneous indication of grades in a query to a student loan banking system through a query interface to the student loan banking system, receiving in response to the query, a specified variable interest rate for a student loan to the one of the end users and a prospective reduced interest rate in consequence of the contemporaneous indication of the grades and displaying in a user interface to the tutor matching system, both the specified variable interest rate, the prospective reduced interest rate and the contemporaneous indication of the grades.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for automated modification of a student loan interest rate in a tutor matching system;

FIG. 2 is a schematic illustration of a tutor matching system adapted for automated modification of a student loan interest rate; and,

FIG. 3 is a flow chart illustrating a process for automated modification of a student loan interest rate in a tutor matching system.

### DETAILED DESCRIPTION OF THE INVENTION

Embodiments of the invention provide for the automated modification of a student loan interest rate in a tutor matching system. In accordance with an embodiment of the invention, an end user registers with a tutor matching system and specifies both an academic institution in which the end user is enrolled as a student, and also a lending organization from which the end user has received a student loan at a specified variable interest rate. The tutor matching system then periodically transmits a query to a query interface of a registrar data retrieval system of the academic institution in order to receive a transcript for the end user including different grades for corresponding completed coursework.

Thereafter, following each receipt of the different grades, using the received different grades the tutor matching system formulates an interest rate reduction query to a query interface of the lending organization in order to receive an indication of the specified variable interest rate, a prospectively different variable interest rate responsive to the different grades, and a date on which the specified variable interest rate becomes fixed. As such, the tutor matching system may continuously display in a portion of a user interface of the tutor matching system for the end user, a motivational indication of the possibility of a reduction of the specified interest rate responsive to the improved academic performance of the end user.

Optionally, the student, in the role of tutor to other students, receives payment in connection with each tutoring session conducted as a tutor for another student. A portion of the payment may then be provided to the lending organization as pre-payment of principal so that the more the student engages in the role as tutor, the less principal balance remains of a correspondent student load and thus a lesser amount of interest is ultimately paid by the student to the lending organization in service of the correspondent student loan.

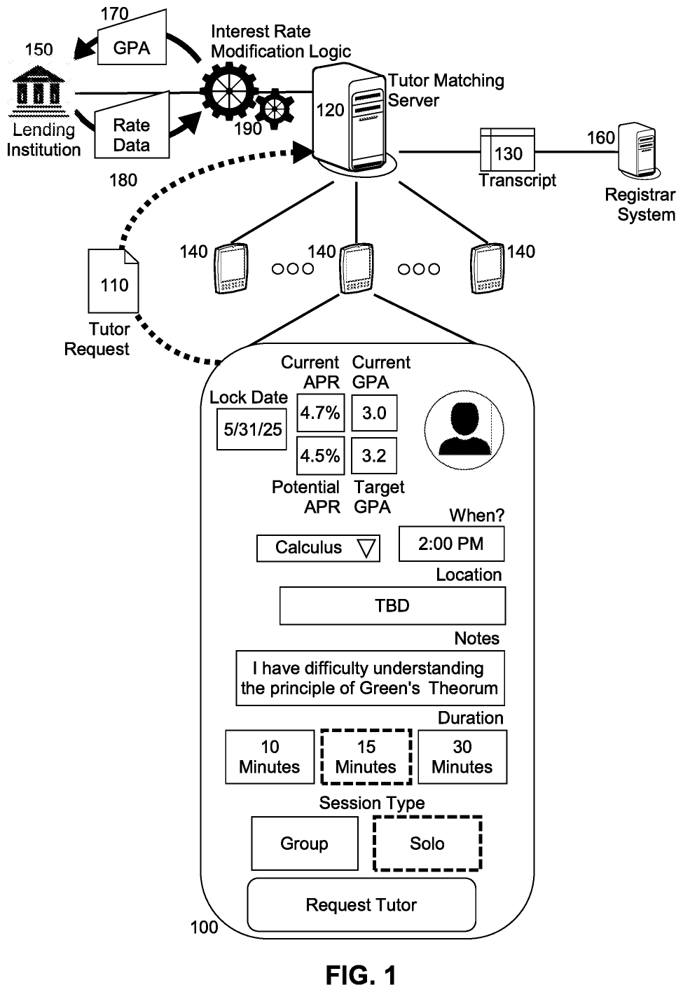

In further illustration, FIG. 1 pictorially shows a process for automated modification of a student loan interest rate in a tutor matching system. As shown in FIG. 1, an end user using a user interface 100 to a tutor matching system displayed within a corresponding computing device 140, for instance a mobile device or a device capable of supporting the operation of a Web browser, registers with a tutor matching server 120 including an indication of an academic institution at which the end user is registered as a student, and also an indication of a lending institution 150 providing financial aid to the end user in support of the attendance by the end user as a student at the academic institution. Thereafter, the end user, as a student, through the user interface 100 formulates a request 110 for tutoring services. The request 110 is formulated through the interaction by the student with different user interface controls of the user interface 100.

In particular, and as a non-limiting example, FIG. 1 shows the user interface 100 as including controls presenting a selectable list of courses for which the student has been contemporaneously registered as indicated by registrar system 160 for the academic institution, and for which tutoring is requested, an input field into which a time for the tutoring session may be specified, a free-form text input field into which additional comments regarding the required tutoring services may be provided, a selection of tutoring session durations, a selection of tutoring session types, and a submit button responsive to which a tutor request 110 including the information provided in the user interface 100 is transmitted over a computer communications network to the tutor matching server 120.

The tutor matching server 120, upon receiving the tutor request 110, generates a request for tutoring. The tutor matching server 120 then broadcasts the request for tutoring to the computing devices 140 of only those of the end users registered as tutor who have completed the requisite coursework in the specified topic and who have achieved a threshold grade sufficient to demonstrate superior knowledge in the specified topic. Each of the selected tutors receiving the broadcast request view the content of the broadcast request in a corresponding user interface (not shown). The tutor matching server 120 then receives one or more different responses to the broadcast request. The tutor matching server 120 selects one of the responses and then establishes a tutoring session for a selected one of the tutors and the student at the specified time.

Of note, as the grade performance of the student improves in consequence of the tutoring, the tutor matching server 120 through coupled interest rate modification logic 190 transmits a computer generated query over a computer communications network to lending institution 150 through a query interface to the lending institution 150 including an indication of a the grade performance of the student as computed from a transcript 130 retrieved by the interest rate modification logic 190 from the registrar system 160 of the academic institution. In this regard, the grade performance can be a listing of grades by subject, an average of the grades by subject, a computed GPA, or a computed change in GPA from a previous computed GPA. In response, the interest rate modification logic 190 receives from over the computer communications network a response from the lending institution 150 including interest rate data 180.

The interest rate data 180 includes both a currently assigned interest rate, a date on which the current interest rate locks as permanent, the grade performance and a prospective interest rate reduced from the current interest rate based upon the grade performance. In this way, the student can be motivated with a periodic reminder of the ability of the end user to further reduce the interest rate of the student loan of the end user by achieving improved grade performance. As well, the student can be motivated to request further tutoring in order to achieve improved grade performance.

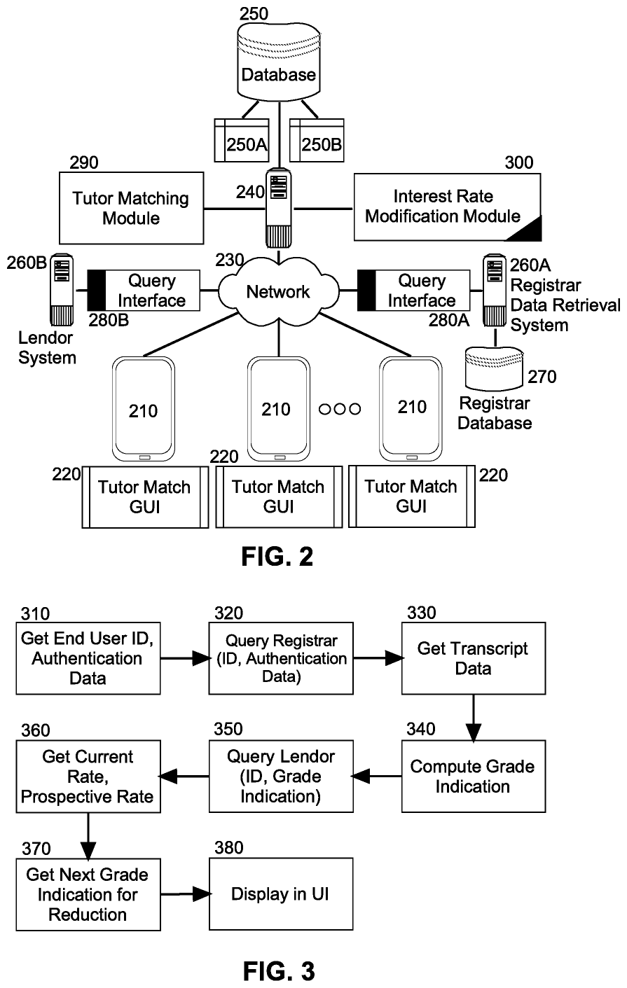

The process described in respect to FIG. 1 can be implemented within a tutor matching data processing system. In further illustration, FIG. 2 schematically shows a tutor matching system adapted for automated modification of a student loan interest rate. The system includes a host computing server 240 including one or more computers, each with memory and at least one processor. The host computing server 240 is communicatively linked to different mobile devices 210 over computer communications network 230, each of the mobile devices 210 belonging either to a student in an academic institution, a tutor at the academic institution, or both.

The host computing server 240 includes a database 250 that may include one or more databases either locally present within the host computing server 240, or accessible remotely by the host computing server 240. The database 250 includes a tutor registry 250A and a student table 250B. The tutor registry 250A includes a listing of different tutors registered to perform tutoring services in connection with one or more academic topics, a grade achieved in a class corresponding to each academic topic, and a most recent rating applied to the corresponding tutor. The student table 250B includes a listing of different students registered to receive tutoring services. Of note, the student table 250B includes for each corresponding student, a set of courses for which the corresponding student is contemporaneously registered at the academic institution.

Importantly, a tutor matching module 290 executes in the memory of the host computing server 240. The tutor matching module 290 includes computer program instructions that during execution, receive through a tutor matching user interface 220 in a mobile device 210 of a tutor request for tutoring services in a specified academic topic of interest at a particular time and location for a specified duration of time. The program instructions during execution additionally locate within the tutor registry 250A, a selection of tutors able to perform the requested tutoring services based upon the completion by each of the tutors of a class corresponding to the specified academic topic for which the tutor received a minimum threshold grade indicated in the tutor registry 250A, such as an “A”.

The program instructions during execution even further broadcast to the selection of tutors, the tutor request for viewing in the user interface 220 of respective ones of the mobile devices 210 of the selection of tutors. Finally, the program instructions during execution receive one or more responses to the broadcast request from ones of the selection of tutors and matches a selected one of the responding tutors to the student issuing the request. Upon completion of the tutoring session, the program instructions transfer credits from the student to the tutor in accordance with a quoted rate for employing the assigned tutor for the tutoring session. In this way, the tutoring session may improve the grade performance of the student.

In this regard, the improvement of the grade performance may influence an interest rate variably established for the student in respect to a student loan granted to the student by a lending institution. More particularly, an interest rate modification module 300 executes in the memory of the host computing server 240. The interest rate modification module 300 includes computer program instructions that during execution, issue a query to a registrar data retrieval system 260A through a query interface 280A to the registrar data retrieval system 260A specifying an identification of a student in a format acceptable by the registrar data retrieval system 260 that is sufficient to cause the registrar data retrieval system 260A to return over the computer communications network 230 to the interest rate modification module 300, transcript data for the student.

The program instructions of the interest rate modification module 300 are further enabled during execution in the host computing server 240 to respond to the receipt of the transcript data by formulating a query including an identification of the student and a computed grade performance for the student. In this regard, the program instructions may compute a grade performance for the student as a GPA, as an average grade amongst a selection of grades in the transcript data, or a change in GPA from a previously computed GPA. The program instructions are even further enabled to transmit the formulated query through a query interface 280B of a lender data processing system 260B of the lending institution including the transcript.

In response to the formulated query, the program instructions are enabled to receive from over the computer communications network 230, a response by the lender system 260B that includes a currently assigned interest rate for the student and also a prospective interest rate based upon the grade performance as well as a date on which the interest rate locks and therefore becomes permanent in respect to the student loan of the student. In this regard, the lender system 260B may compute the prospective interest rate based upon a number of factors including the following:
Previous GPA from the secondary school from which the student previously graduated.
A quality rating of the academic institution relative to other academic institutions.
A quality rating of an academic major at the academic institutuion relative to the same academic major at different academic institutions.
A difficulty rating of the academic major.
The GPA of the student at each semester completed by the student.
A rate of pre-payment of the student loan by the student.
A frequency at which the student transfers from one academic institution to another.
A frequency at which the student changes academic majors at the academic institution.
A frequency at which the student assumes a role of tutor and tutors other students.
   Thus, by way of example, the prospective interest rate at the conclusion of each semester may be computed in accordance with the following formula:

Prospective_Rate==Published_Prime_Rate+Traditional_Market_Student_Premium_Rate %-1/(High-School_GPA*weight1+University_GPA*weight2*(1/Degree_Difficulty_Factor))

Finally, the program instructions of the interest rate modification module 300 are enabled to transmit for display in the user interface 220 of the student, an indication of the prospective interest rate and the grade performance necessary to achieve the prospective interest rate.

In even yet further illustration of the operation of the interest rate modification module 300, FIG. 3 is a flow chart illustrating a process for automated modification of a student loan interest rate in a tutor matching system. Beginning in block 310, an end user identification for a student is retrieved along with authentication data in respect both to a registrar data retrieval system and also a lender data processing system. In block 320, a query is issued to the registrar data retrieval system with the identity of the student and the authentication data in response to which transcript data is received from the registrar data retrieval system in block 330.

In block 340, a grade performance is computed for the student based upon the transcript data and in block 350, the lender data processing system is then queried with the grade performance in response to which in block 360 a current interest rate assigned to the student, and a prospective interest rate based upon the grade performance are received from the lender data processing system. As well, in block 370 a next grade performance is received in response to which an even further reduction in interest rate may be offered. Finally, in block 380 the current interest rate, prospective interest rate and next grade performance are displayed in a user interface of a mobile device of the student.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method for automated modification of a student loan interest rate in a tutor matching system, the method comprising:
periodically retrieving for an end user of the tutor matching system for a duration of time during which the end user remains enrolled at an academic institution, a contemporaneous indication of grades for coursework for which the end user has registered at the academic institution; and,
responsive to each retrieval of the contemporaneous indication of the grades:
transmitting the contemporaneous indication of grades in a query to a student loan banking system through a query interface to the student loan banking system;
receiving in response to the query, a specified variable interest rate for a student loan already lent to the end user, a prospective reduced interest rate for the student loan in consequence of the contemporaneous indication of the grades, and a threshold value beyond the contemporaneous indication of the grades at which an even further reduced interest rate occurs; and
displaying in a user interface to the tutor matching system, the specified variable interest rate, the prospective reduced interest rate and the contemporaneous indication of the grades and the threshold value beyond the contemporaneous indication of the grades at which an even further reduced interest rate occurs.

2. The method of claim 1, wherein the contemporaneous indication of the grades is a grade point average (GPA).

3. The method of claim 2, wherein the contemporaneous indication of the grades is a change in grade point average (GPA) over time.

4. The method of claim 1, further comprising displaying in the user interface a date on which the prospective reduced interest rate becomes fixed.

5. (canceled)

6. The method of claim 1, wherein the periodic retrieval of the contemporaneous indication of the grades comprises:
identifying a pre-stored profile in the tutor matching system for the academic institution;
extracting from the pre-stored profile, a network address of a registrar data retrieval system and a specification of a query interface to the registrar data retrieval system;
generating a query consistent with the specification to retrieve a transcript for the end user;
transmitting the generated query to the network address of the registrar data retrieval system;
receiving in response to the generated query, transcript data comprising a listing of courses for which the end user has registered and corresponding grades; and,
computing the contemporaneous indication of the grades from the corresponding grades in the transcript data.

7. A tutor matching data processing system configured for automated modification of a student loan interest rate, the system comprising:
a host computing platform comprising a data store and one or more computers, each with memory and at least one processor, the host computing platform having a communicative coupling to different mobile devices of different end users over a computer communications network;
a tutor matching engine executing in the host computing platform and matching students requesting tutoring services from respective ones of the mobile devices, with tutors accepting the requested tutoring services from respective ones of the mobile devices; and,
an automated student loan interest rate modification module comprising computer program instructions enabled during execution in the memory of the host computing platform to perform:
periodically retrieving for one of the end users of the tutor matching system for a duration of time during which the one of the end users remains enrolled at an academic institution, a contemporaneous indication of grades for coursework for which the one of the end users has registered at the academic institution; and,
responsive to each retrieval of the contemporaneous indication of the grades:
transmitting the contemporaneous indication of the grades in a query to a student loan banking system through a query interface to the student loan banking system;
receiving in response to the query, a specified variable interest rate for a student loan already lent to the end user, a prospective reduced interest rate for the student loan in consequence of the contemporaneous indication of the grades, and a threshold value beyond the contemporaneous indication of the grades at which an even further reduced interest rate occurs; and
displaying in a user interface to the tutor matching system, the specified variable interest rate, the prospective reduced interest rate and the contemporaneous indication of the grades and the threshold value beyond the contemporaneous indication of the grades at which an even further reduced interest rate occurs.

8. The system of claim 7, wherein the contemporaneous indication of the grades is a grade point average (GPA).

9. The system of claim 8, wherein the contemporaneous indication of the grades is a change in grade point average (GPA) over time.

10. The system of claim 7, wherein the program instructions further perform displaying in the user interface a date on which the prospective reduced interest rate becomes fixed.

11. (canceled)

12. The system of claim 7, wherein the periodic retrieval of the contemporaneous indication of grades comprises:
identifying a pre-stored profile in the tutor matching system for the academic institution;
extracting from the pre-stored profile, a network address of a registrar data retrieval system and a specification of a query interface to the registrar data retrieval system;
generating a query consistent with the specification to retrieve a transcript for the one of the end users;
transmitting the generated query to the network address of the registrar data retrieval system;
receiving in response to the generated query, transcript data comprising a listing of courses for which the one of the end users has registered and corresponding grades; and,
computing the contemporaneous indication of the grades from the corresponding grades in the transcript data.

13. A computer program product for automated modification of a student loan interest rate in a tutor matching system, the computer program product including a computer readable storage medium having program instructions embodied therewith, the program instructions executable by a device to cause the device to perform a method including:
periodically retrieving for an end user of the tutor matching system for a duration of time during which the end user remains enrolled at an academic institution, a contemporaneous indication of grades for coursework for which the end user has registered at the academic institution; and,
responsive to each retrieval of the contemporaneous indication of the grades:
transmitting the contemporaneous indication of the grades in a query to a student loan banking system through a query interface to the student loan banking system;
receiving in response to the query, a specified variable interest rate for a student loan already lent to the end user, a prospective reduced interest rate for the student loan in consequence of the contemporaneous indication of the grades, and a threshold value beyond the contemporaneous indication of the grades at which an even further reduced interest rate occurs; and
displaying in a user interface to the tutor matching system, the specified variable interest rate, the prospective reduced interest rate and the contemporaneous indication of the grades and the threshold value beyond the contemporaneous indication of the grades at which an even further reduced interest rate occurs.

14. The computer program product of claim 13, wherein the contemporaneous indication of the grades is a grade point average (GPA).

15. The computer program product of claim 14, wherein the contemporaneous indication of the grades is a change in grade point average (GPA) over time.

16. The computer program product of claim 13, wherein the method further comprises displaying in the user interface a date on which the prospective reduced interest rate becomes fixed.

17. (canceled)

18. The computer program product of claim 13, wherein the periodic retrieval of the contemporaneous indication of the grades comprises:
identifying a pre-stored profile in the tutor matching system for the academic institution;
extracting from the pre-stored profile, a network address of a registrar data retrieval system and a specification of a query interface to the registrar data retrieval system;
generating a query consistent with the specification to retrieve a transcript for the end user;
transmitting the generated query to the network address of the registrar data retrieval system;
receiving in response to the generated query, transcript data comprising a listing of courses for which the end user has registered and corresponding grades; and,
computing the contemporaneous indication of the grades from the corresponding grades in the transcript data.
